(19) United States
(12) Patent Application Publication
(10) Pub. No.: US 2006/0222981 A1
(43) Pub. Date: Oct. 5, 2006

(54) Electrophotographic developer

(75) Inventor: Nobuyuki Aoki, Shizuoka-shi (JP)

Correspondence Address: OLIFF & BERRIDGE, PLC, P.O. BOX 19928, ALEXANDRIA, VA, 22320, US

(73) Assignee: TOMOEGAWA PAPER CO., LTD., TOKYO (JP)

(21) Appl. No.: 10/545,692

(22) PCT Filed: Feb. 27, 2004
(86) PCT No.: PCT/JP04/02367

§ 371 Date: Aug. 15, 2005

(30) Foreign Application Priority Data
Feb. 28, 2003 (JP) 2003-053741

(51) Int. Cl. G03G 9/083

(52) U.S. Cl. 430/106.1; 430/109.3

(57) ABSTRACT

A developer for electrophotography comprising of a carrier and a magnetic toner containing cyclo-olefin copolymer resin as a binder resin. A carrier in which a surface of the core particle is coated by resin coating agent or a magnetic material dispersed resin carrier, is desirable. In the case in which saturation magnetization of the carrier at external magnetic field of 5 kOe is Sc, it is desirable that saturation magnetization St of magnetic toner at external magnetic field of 5 kOe satisfy the relationship of 0.10 Sc≦St≦0.40 Sc. In this way, the developer for electrophotography in which environmental resistance is superior, appropriate image density is maintained even after a large number of copies are made, fogging and toner dusting are minimized, and the amount of toner consumed is reduced, can be provided by the present invention.

### TECHNICAL FIELD

The present invention relates to a developer for electrophotography used in image-forming devices such as copy machines, printers, facsimile machines or the like in which electrophotographic technology is used.

### Background Art

As a dry-type developer used in image-forming devices, there are basically three kinds of developers, that is, a two-components developer having a toner and a carrier such as ferrite powder, iron powder, glass beads or the like, a magnetic one-component developer having a toner containing magnetic powder therein, and a non-magnetic one-component developer in which magnetic power is not used. A toner used in these developers contains binder resin and coloring agent as main components, and further contains wax to improve fixability to recording sheets at low temperature, and charge controlling agent to add polarity (positive charge or negative charge). The toner is prepared by mixing these materials in predetermined ratio, by forming into powders by melting and kneading, pulverizing, classifying and the like, and finally, by performing surface treatment using silica, titanium oxide, alumina, and kinds of resin fine particles to control flowability, chargeability, cleaning property, and storage stability.

In the two-components developer, in order to conserve resources and minimize cost, as a relatively simple developing device, a developer having magnetic toner and a carrier, which is something between the two-components developer and the one-component developer, has been practically used.

However, in the image forming device in which such a developer having the magnetic toner and the carrier is employed, there are problems of fogging and toner dusting when a large number of copies is made. Furthermore, since the toner contains magnetic material having higher specific gravity than the binder resin, the amount of toner consumed for each copy is increased.

Under such circumstances, as a binder resin for toner which has recently attracted attention, cyclo-olefin copolymer resin can be mentioned, and a toner including such a resin is disclosed in Japanese Unexamined Patent Application Publications No. Hei 09-101631 and No. 2000-284528, for example. However, there has conventionally been no example in which the resin is used in a developer having magnetic toner and a carrier.

Furthermore, the problem of consuming large amounts of toner has been conventionally solved by controlling the amount of toner developed on paper, and particularly by controlling the properties of charging and intrinsic volume resistance of the toner and carrier. Such controls are very difficult.

### DISCLOSURE OF THE INVENTION

An object of the present invention is to provide a developer in which the above-mentioned problems can be solved, sufficient image density can be maintained for long periods, toner dusting and fogging can be reduced, and amount of toner consumed can be reduced.

The developer for electrophotography of the present invention contains carrier and magnetic toner having cyclo-olefin copolymer as a binder resin. In the developer for electrophotography, in the case in which saturation magnetization of the carrier at external magnetic field of 5 kOe is Sc, it is desirable that saturation magnetization St of magnetic toner at external magnetic field of 5 kOe satisfy the relationship of 0.10Sc≦St≦0.40 Sc.

By using the developer of the present invention, the toner is difficult to be broken down to fine particles even if a mechanical stress is impressed to it in a developing device. Therefore, the developer can maintain an appropriate amount of triboelectric charge, and exhibits superior environmental resistance and high image qualities, and reduces easily the amount of toner consumed.

### THE BEST MODE FOR CARRYING OUT THE INVENTION

The desirable embodiment of the present invention is further explained below.

The toner used in the present invention consists of at least toner particles, and a fluidizing agent such as hydrophobic silica can be added if necessary. The toner particle contains cyclo-olefin copolymer resin as a binder resin, and if necessary, coloring agent, releasing agent, charge controlling agent, or the like can be added.

In the toner particle of the present invention, the binder resin is required to contain at least cyclo-olefin copolymer resin. Japanese Unexamined Patent Application Publication No. Hei 09-101631 discloses that cyclo-olefin copolymer resins exhibit superior environmental resistance and are difficult to be broken, and that they can be used as resins for toners for magnetic one-component developers instead of conventional binder resins such as polyester resin, styrene-(metha)acrylic acid ester copolymer resin or the like. However, there has been no example exhibited in a two-components developer having magnetic toner and carrier, since image property is influenced by the magnetic relationship between magnetic toner and carrier in it. Furthermore, since cyclo-olefin copolymer resin has a lower specific gravity than a conventional resin, it is possible to reduce the amount of toner consumed.

The cyclo-olefin copolymer resins are a polyolefin resins having a ring structure unit, for example, a copolymer of α-olefin such as ethylene, propylene, butylene, or the like (acyclic olefin) and cyclo-olefin having double bonds such as cyclohexene, norbornene, tetracyclododecene, or the like. The copolymer can be a random copolymer or a block copolymer. These cyclo-olefin copolymers can be obtained by conventional polymerizing methods in which metallocene based or Ziegler-based catalyst is used. In addition, the cyclo-olefin copolymer can be modified by introducing a carboxylic group. For example, methods disclosed in Japanese Unexamined Patent Application Publication No. Hei 05-339327, No. Hei 05-9223, and No. Hei 06-271628 can perform to synthesize the copolymer.

In the present invention, one kind of the cyclo-olefin copolymer resin obtained by the above-mentioned method can be used, or a mixture of plural kinds of cyclo-olefin copolymer resins having different average molecular weight can be used.

In the present invention, other kinds of resin can be used with the above-mentioned cyclo-olefin copolymer resin in the binder resin. The ratio of the cyclo-olefin copolymer resin in the binder resin is desirably in a range from 50 to 100 wt %, and more desirably in a range from 80 to 100 wt %. In the case in which the ratio of the cyclo-olefin copolymer resin is less than 50 wt %, it will be difficult to maintain sufficient image density under any environment, to reduce fogging and toner dusting, and to reduce the amount of toner consumed, when a large number of copies is made.

As other resins which can be used with the cyclo-olefin copolymer resin, polystyrene resin, polyacrylic acid ester resin, styrene-acrylic acid ester copolymer resin, styrene-methacrylic acid ester copolymer resin, polyvinyl chloride, polyvinyl acetate, polyvinylidene chloride, phenol resin, epoxy resin, polyester resin, hydrogenated rosin, cyclized rubber, polylactic acid resin, terpene phenol resin, olefin resin or the like can be mentioned.

In the present invention, it is desirable that wax is contained to improve fixability at low temperature and releasability at fusing. As the wax, polyolefin based wax such as polyethylene wax, polypropylene wax or the like, synthesized wax such as Fischer-Tropsch wax or the like, petroleum wax such as paraffin wax, microcrystalline wax or the like, carnauba wax, candelilla wax, rice wax, hydrogenated castor oil or the like can be mentioned. In addition, for the purpose of controlling micro-dispersion of wax in the cyclo-olefin copolymer resin, it is desirable to use modified polyethylene wax. Two or more kinds of these waxes can be used together, also. The amount of the wax contained is desirably in a range from 0.5 to 10.0 wt % in the toner particle, and more desirably in a range from 1.0 to 8.0 wt %. In the case in which the amount contained is less than 0.5 wt %, fixability at low temperature and releasability at fusing is not sufficient, and in the case in which the amount contained is more than 10.0 wt %, storage stability is not sufficient.

Plural kinds of wax can be used if necessary, and it is desirable that all the waxes used have melting points shown by endothermic peaks of DSC not less than 60° C., and more desirable not less than 80° C. In the case in which the melting point is less than 60° C., blocking of toner particles easily occurs, and there are problems in durability.

In the case in which it is used in a heat pressing type fusing device in a copy machine, printer or the like, in particular, a wax having a melting point shown by endothermic peaks of DSC in a range from 60 to 100° C. is desirable. As a wax having such a characteristic, in particular, Fischer-Tropsch wax or carnauba wax is desirable. That is why these waxes can compensate for reduction of fixability depending on relative decrease of the resin part due to the containing of the magnetic material.

The method of measuring the melting point (endothermic peak of DSC) is as follows. About 10 mg of sample was put in an aluminum cell, the cell was placed in a differential scanning calorimeter (DSC) (trade name: SSC-5200, produced by Seiko Instruments Inc.), and N₂ gas is blown at 50 ml per minute. A process in which temperature was increased from 20 to 180° C. at a rate of 10° C. per minute and then decreased from 180 to 20° C. rapidly, was repeated two times, and the endothermic peak temperature at that time (i.e. the second time) was measured.

As a coloring agent, carbon black, aniline blue, calco oil blue, chrome yellow, ultramarine blue, Dupont oil red, quinoline yellow, methylene blue chloride, phthalocyanine blue, malachite green oxalate, lamp black, rose Bengal or the like can be mentioned. The coloring agent is required to be sufficiently contained to form a visible image having sufficient density. For example, it is contained in a range from about 1 to 20 parts by weight, desirably in a range from 1 to 7 parts by weight, to 100 parts by weight of the binder resin.

The magnetic toner used in the present invention desirably contains charge controlling agent if necessary. The charge controlling agent is added to add polarity; there are two kinds of charge controlling agent such as for positively charged toner and for negatively charged toner. As a charge controlling agent for positively charged toner, nigrosine dye, quaternary ammonium salt, pyridinium salt, azine, low molecular weight polymer having cationic functional group (e.g., trade name: FCA201-PS, produced by Fujikura Kasei Co., Ltd.), and the like can be mentioned. As a charge controlling agent for negatively charged toner, azo-type metal complex, salicylic acid type metal complex, boron-type complex, low molecular weight polymer having anionic functional group (e.g., trade name: FCA-1001-NS, produced by Fujikura Kasei Co., Ltd.), and the like can be mentioned. Desirable content amounts thereof are in a range from 0.1 to 5 parts by weight to 100 parts by weight of binder resin. They can be used alone or in combination. From the viewpoints of safety to the environment and risk to the human body, low molecular weight polymers having functional groups and boron-type complexes are desirable. As the boron-type complex, LR-147 produced by Japan Carlit Co., Ltd., is commercially available.

The magnetic toner used in the present invention is required to contain magnetic powder. As the magnetic powder, fine particles of ferrite powder, magnetite powder, iron powder or the like can be mentioned. As the ferrite powder, mixed-sintered material of MeO—Fe₂O₃ can be used. In this case, MeO is an oxide of Mn, Zn, Ni, Ba, Co, Cu, Li, Mg, Cr, Ca, V or the like, and one or more kinds thereof can be used. As the magnetite powder, mixed-sintered material of FeO—Fe₂O₃ can be used. Particle diameter of the magnetic powder is desirably in a range from 0.05 to 3 μm.

Toner particles used in the magnetic toner of the present invention can be produced by mixing the above-mentioned raw material and other additive materials if necessary in predetermined ratio, melting and kneading the mixture, pulverizing, and classifying. Alternatively, the toner particle can be produced by performing a polymerizing method using raw materials of the above mentioned materials. Volume average particle diameter of the toner particle is generally set in a range from 5 to 15 μm.

Hydrophobic silica fine particles as fluidizing agent is desirably adhered to the toner particle in a range from 0.1 to 1.5 wt %. In the case in which the adhered amount of the hydrophobic silica fine particle is less than 0.1 wt %, flowing properties of the toner are reduced and toner supply becomes insufficient and storage stability are also reduced. In the case in which the adhered amount is more than 1.5 wt %, the hydrophobic silica may easily fall off from toner particles, and problem of film forming or the like may occur.

In addition, magnetic powder, alumina, talc, clay, calcium carbonate, magnesium carbonate, titanium oxide, or some kinds of resin fine particles can be adhered to the toner surface to control flowing properties, charging properties, cleaning properties, and storage stability of the toner. To adhere the above-mentioned fine silica particles or the like on the toner particles, a method in which a generally used agitator such as a turbine-type agitator, Henschel mixer, super mixer or the like is used, can be mentioned.

In the magnetic toner of the present invention, it is desirable that the saturation magnetization St at an external magnetic field of 5 kOe, in the case in which saturation magnetization of the carrier at an external magnetic field of 5 kOe is Sc, satisfy the relation ship 0.10 Sc≦St≦0.40 Sc.

In the case in which the saturation magnetization of the toner St is less than 0.10 Sc, magnetic force is small, the toner is difficult to be held on the surface of the carrier or developing roller, and the toner easily produces fogging in an image. Furthermore, toner dusting easily occurs. On the other hand, in the case in which the St is more than 0.40 Sc, the toner is difficult to be developed, image density is reduced, and detention time of toner in the developer is elongated to have a bad effect to charging property of the toner.

The saturation magnetization is a measured value in which the external magnetic field of 5 kOe is applied to the sample using a vibration sample type magnetometer (trade name: VSM-P7, produced by Toei Industry Co., Ltd.).

A desirable carrier used in the developer of the present invention is further explained below. The desirable carrier for the present invention is a carrier in which surface of a core particle is coated with a resin coating agent. In the case in which the resin coating is not performed, toner will be broken by friction with the carrier, causing toner dusting. As a core particle, magnetic material such as iron powder, magnetite, ferrite or the like can be mentioned. In particular, ferrite and/or magnetite are desirable. The core particle of the ferrite is a sintered material of a trivalent oxide of iron and metal oxide shown by the following formula.
(MO)ₓ(Fe₂O₃)_{y}
(In the formula, M is one or more kinds of metals selected from the group of copper, zinc, manganese, magnesium, nickel, barium, lithium, vanadium, calcium, chromium, cobalt, iron or the like. X and Y have a mole ratio which is determined depending on required properties such as magnetic properties. The formula shows magnetite in the case in which M is iron.)

The above-mentioned ferrite can be obtained by a conventional method. For example, a trivalent iron oxide and a metal oxide, which are raw materials of the ferrite having the above-mentioned formula, are sufficiently mixed in a wet condition to make slurry. The obtained slurry raw material is formed into particles by a spray-dry method and is then dried. The dried particles are sintered, crushed, and classified. The average particle diameter of the core particle is ordinarily desirably in a range from 10 to 500 μm, and more desirably in a range from 20 to 200 μm.

As a resin which constitutes the resin coating agent, silicone resin, silicone graft resin, acrylic based resin, styrene based resin, urethane based resin, epoxy resin, polyamide resin, polyester resin, acetal resin, polycarbonate resin, phenol resin, vinyl chloride resin, vinyl acetate resin, cellulose resin, polyolefin resin, styrene-acrylic copolymer resin, styrene-butadiene copolymer resin, fluorine based resin or the like can be mentioned. These resins can be used alone or in combination, and a copolymer resin of the monomer components of above-mentioned resin can be used. In particular, silicone resin can reduce contamination (spent) with toner to the surface of the carrier.

The resin coating agent can be obtained by dissolving the resin in a solvent such as toluene, trichloroethylene, trichloromethane, methylethylketone, adding an additive agent such as carbon black, magnetic powder, charge controlling agent, or cross-linking agent, cross-linking promoting agent if necessary, and mixing by a mixer such as Henschel mixer or a super mixer. The carrier for electrophotography of the present invention can be obtained by coating the resin coating agent on the surface of the core particle by an ordinary method. For example, in a production process using a fluidized bed method, gas flow is blown upward from below the fluidized layer to keep core particles of ferrite or the like in a floating-suspended condition, and then the resin coating agent is sprayed on the fluidized particles to adhere on the surface of the core particles. Then, a membrane of the above-mentioned resin coating agent is dried to form a dry coating film, and the carrier is classified to obtain the carrier of the present invention having desirable particle diameter.

It is desirable that the core particle of the resin coated carrier of the present invention be ferrite and/or magnetite.

As another desirable carrier of the present invention, magnetic material dispersed resin carrier may be mentioned. The magnetic material dispersed resin carrier has a structure in which magnetic particles are dispersed and held in a resin material. Since the magnetic material dispersed resin carrier has a structure in which magnetic particles are dispersed in resin material, the specific gravity of the carrier can be made close to the specific gravity of the toner. Therefore, stirring and mixing of carrier and toner is easy, and the carrier and the toner can be mixed to be highly dispersed with no nonuniformity. In addition, since the surface of the magnetic material dispersed resin carrier is nearly completely resin, there is almost no stress on the toner, and breaking of toner and carrier spent (contamination with toner to the surface of the carrier) can be reduced.

As a resin used in the magnetic material dispersed resin carrier, the one of the following is desirably used, but this is not limited in particular. As such a resin, phenol based resin, styrene based resin, acrylic based resin, styrene/acrylic based resin, olefin based resin, halogen based vinyl polymer, vinyl ester based polymer, polyester resin, polyurethane resin, epoxy resin, silicone resin, melamine resin or the like can be used. Furthermore, a modified resin of the above-mentioned resin such as urethane modified silicone resin, or urethane modified polyester resin can be used.

As a magnetic material, all the magnetic materials ordinarily used can be used. As the magnetic material, strong magnetic oxides such as ferrite, magnetite or the like, strong magnetic metals such as iron, cobalt, nickel or the like, or other magnetic compounds or alloys can be mentioned.

Weight average particle diameter of the magnetic material is desirably in a range from 10 to 60 μm to obtain a carrier having a desirable particle diameter. The weight average particle diameter was measured according to Japanese Industrial Standard Z8815.

Contained ratio of the magnetic material is desirably in a range from 50 to 95 wt % of the carrier weight, and more desirably in a range from 70 to 90 wt %. In the case in which the ratio is less than 50 wt %, magnetic properties are insufficient, carrier scattering from developing sleeve may occur, and the carrier may be easily adhered to the photoreceptor. In the case in which the ratio is more than 95 wt %, the surface strength of the carrier is reduced, and the specific gravity of the carrier is increased.

In the carrier of the present invention, charge controlling agent, electrical resistance controlling agent, filler or the like can be added to control charging and electrical resistance and to improve strength.

Any conventional method can be employed to produce the magnetic material dispersed resin carrier of the present invention. For example, the above-mentioned binder resin and magnetic material, and if necessary, other additives such as carbon black, charge controlling agent, inorganic fine particles or the like, may be mixed in sufficiently, and melted and kneaded. The mixture is crushed coarsely and then pulverized finely into particles, and the particles are classified in desirable diameters.

The magnetic material dispersed resin carrier of the present invention obtained above desirably has a weight average particle diameter in a range from 15 to 60 μm, and more desirably in a range from 20 to 50 μm. In the case in which the diameter is less than 15 μm, the carrier is easily adhered to the photoreceptor, and in the case in which the diameter is more than 60 μm, it will become difficult to obtain a high quality image.

The present invention is further explained by way of Examples and Comparative Examples. However, the present invention is not limited in range thereto.

The following toners A to H were prepared.

Preparation of toner A

| | | |
|---|---|---|
| Cyclo-olefin copolymer resin (trade | 100 | parts by weight |
| name: TOPAS COC, produced by Ticona | | |
| GmbH, ethylene-norbornene copolymer) | | |
| Polypropylene wax (trade name: Viscol | 3 | parts by weight |
| 550p, produced by Sanyo Chemical | | |
| Industries, Ltd., melting point: 145° C.) | | |
| Fischer-Tropsch wax (trade name: FT-100, | 2 | parts by weight |
| produced by Nippon Seiro Co., | | |
| Ltd., melting point: 92° C.) | | |
| Metal containing dye (trade name: | 2 | parts by weight |
| Bontron S-34, produced by Orient | | |
| Chemical Industries, Ltd.) | | |
| Magnetic iron oxide (trade name: | 10 | parts by weight |
| BL-10, produced by Titan Kogyo K.K.) | | |

Raw materials having the ratios shown above were premixed by a super mixer, heat melted and kneaded by a biaxial extruder, pulverized by a jet mil, and classified by a dry-type air flow classifier, to obtain toner particles having volume average particle diameter of 10 μm. 0.5 wt % of hydrophobic silica (trade name: R-976, produced by Nippon Aerosil Co., Ltd.) was added to the toner particles and they were mixed by a Henschel mixer for 3 minutes a at circumferential velocity of 50 m/sec, to obtain Toner A.

Preparation of Toner B

Except that 30 parts by weight of the magnetic iron oxide was used, toner B was produced in a manner similar to that of the toner A.

Preparation of Toner C

Except that 60 parts by weight of the magnetic iron oxide was used, toner C was produced in a manner similar to that of the toner A.

Preparation of toner D

| | | |
|---|---|---|
| Cyclo-olefin copolymer resin (trade | 100 | parts by weight |
| name: TOPAS COC, produced by Ticona | | |
| GmbH, ethylene-norbornene copolymer) | | |
| Polypropylene wax (trade name: Viscol | 3 | parts by weight |
| 550p, produced by Sanyo Chemical | | |
| Industries, Ltd., melting point: 145° C.) | | |
| Fischer-Tropsch wax (trade name: FT-100, | 2 | parts by weight |
| produced by Nippon Seiro Co., | | |
| Ltd., melting point: 92° C.) | | |
| Metal containing dye (trade name: | 2 | parts by weight |
| Bontron S-34, produced by Orient | | |
| Chemical Industries, Ltd.) | | |
| Magnetic iron oxide (trade name: | 10 | parts by weight |
| EPT-1002, produced by Toda Kogyo | | |
| Corp.) | | |

Using raw materials having the ratios shown above, the toner D was produced in a manner similar to that of the toner A.

Preparation of Toner E

Except that 50 parts by weight of the magnetic iron oxide was used, toner E was produced in a manner similar to that of the toner D.

Preparation of Toner F

Except that 60 parts by weight of the magnetic iron oxide was used, toner F was produced in a manner similar to that of the toner D.

Preparation of toner G

| | | |
|---|---|---|
| Polyester resin (Tg = 61° C., Mn = 4200, | 100 | parts by weight |
| Mw = 160000, component insoluble | | |
| in THF: 14%) | | |
| Polypropylene wax (trade name: Viscol | 3 | parts by weight |
| 550p, produced by Sanyo Chemical | | |
| Industries, Ltd., melting point: 145° C.) | | |
| Fischer-Tropsch wax (trade name: | 2 | parts by weight |
| FT-100, produced by Nippon Seiro Co., | | |
| Ltd., melting point: 92° C.) | | |
| Metal containing dye (trade name: | 2 | parts by weight |
| Bontron S-34, produced by Orient | | |
| Chemical Industries Co., Ltd.) | | |
| Magnetic iron oxide (trade name: BL-10, | 10 | parts by weight |
| produced by Titan Kogyo K.K.) | | |

Using raw materials having the ratios shown above, the toner G was produced in a manner similar to that of the toner A.

Preparation of toner H

| | | |
|---|---|---|
| Styrene/acrylic acid ester copolymer | 100 | parts by weight |
| resin (trade name: CPR-100, | | |
| produced by Mitsui Chemicals, Inc.) | | |
| Polypropylene wax (trade name: Viscol | 3 | parts by weight |
| 550p, produced by Sanyo Chemical | | |
| Industries, Ltd., melting point: 145° C.) | | |
| Fischer-Tropsch wax (trade name: FT-100, | 2 | parts by weight |
| produced by Nippon Seiro Co., | | |
| Ltd., melting point: 92° C.) | | |
| Metal containing dye (trade name: | 2 | parts by weight |
| Bontron S-34, produced by Orient | | |
| Chemical Industries Co., Ltd.) | | |
| Magnetic iron oxide (trade name: BL-10, | 60 | parts by weight |
| produced by Titan Kogyo K.K.) | | |

Using raw materials having the ratios shown above, the toner H was produced in a manner similar to that of the toner A.

Preparation of Carriers A to D

Carriers A to D having the following saturation magnetization Sc at external magnetic field of 5 kOe were prepared.

Carrier A

(Silicone resin coated ferrite carrier, Sc=50 emu/g)
   Carrier B
(Acrylic resin coated ferrite carrier, Sc=60 emu/g)
   Carrier C
(Acrylic resin coated magnetite carrier, Sc=80 emu/g)
   Carrier D
(Ferrite carrier having no resin coat, Sc=50 emu/g)

The carrier A was produced as follows. 100 parts by weight of silicone resin was dissolved in 500 parts by weight of toluene to obtain a resin coating agent. Next, a device based on a fluidized bed method, 1 part by weight of the resin coat agent (corresponding to the amount of silicone resin), and 100 parts by weight of commercially available non-coated ferrite carrier were prepared. The ferrite carrier was kept floating in a gas flow, and the resin coating agent was sprayed to adhere the resin coating agent on the surface of the ferrite particles, to obtain carrier cores coated by resin. The carrier core was heated at 60° C. for 24 hours to harden the resin, and the carrier A for electrophotography of the present invention was obtained. Furthermore, except that the core particles were substituted by other kinds having different saturation magnetization, the carriers B and C were produced in a similar manner.

4 parts by weight of each toner A to H and 100 parts by weight of each carrier were mixed to produce the developers of the Examples and Comparative Examples shown in Table 1.

TABLE 1

| | | | Saturation | Saturation | |
|---|---|---|---|---|---|
| | | | magnetization | magnetization | |
| | | | of toner | of carrier | |
| | | Toner | (St) | (Sc) | 0.10 Sc-0.40 Sc |
| Example 1 | Developer 1 | A | 7.7 | A 50 | 5-20 |
| Example 2 | Developer 2 | B | 19.6 | A 50 | 5-20 |
| Example 3 | Developer 3 | D | 7.0 | A 50 | 5-20 |
| Example 4 | Developer 4 | A | 7.7 | B 60 | 6-24 |
| Example 5 | Developer 5 | B | 19.6 | B 60 | 6-24 |
| Example 6 | Developer 6 | E | 25.7 | C 80 | 8-32 |
| Example 7 | Developer 7 | F | 28.9 | C 80 | 8-32 |
| Example 8 | Developer 8 | C | 30.7 | C 80 | 8-32 |
| Comparative | Developer 9 | G | 7.9 | A 50 | 5-20 |
| Example 1 | | | | | |
| Comparative | Developer 10 | H | 31.3 | C 80 | 8-32 |
| Example 2 | | | | | |

Next, using a printer (trade name: JX-9500, produced by Sharp Corporation) under conditions of 25° C. and 55% RH, while each developer was set in the developing device and corresponding toner was supplied, a pattern having black color ratio of 6% was copied on 3000 sheets of A4 copy paper, the developers of Examples 1 to 8 and Comparative Examples 1 and 2 were evaluated. The results are shown in Table 2.

Furthermore, the developers of Example 1 and Comparative Example 1 were also evaluated under conditions of low temperature and low humidity at 10° C. and 20% RH. The results are shown in Table 3.

Image density (ID) was evaluated by measuring a solid image part by a Macbeth reflection densitometer (trade name: RD-914). Fogging (BG) was evaluated by measuring whiteness of the non-image part before and after copying by a color meter (trade name: ZE2000, produced by Nippon Denshoku Industries Co., Ltd.), and the difference of whiteness thereof was calculated. Toner dusting was evaluated by observing contaminaed toner around the developing device; ◯ means no toner contamination and X means substantial toner contamination.

Consumed amount of toner is the weight of toner adhering to a sheet of A4 copy paper (calculated at beginning of copying and after 3000 times).

TABLE 2

| | | | After 3000 sheets | | | |
|---|---|---|---|---|---|---|
| | | | | | Average toner | |
| | Initial | | | | consumption | |
| | ID | BG | ID | BG | (mg/sheet) | Dusting |
| Example 1 | 1.42 | 0.65 | 1.41 | 0.69 | 30.4 | ∘ |
| Example 2 | 1.39 | 0.45 | 1.38 | 0.55 | 28.8 | ∘ |
| Example 3 | 1.44 | 0.73 | 1.43 | 0.77 | 26.9 | ∘ |
| Example 4 | 1.45 | 0.77 | 1.45 | 0.80 | 26.8 | ∘ |
| Example 5 | 1.39 | 0.72 | 1.38 | 0.79 | 28.3 | ∘ |
| Example 6 | 1.40 | 0.59 | 1.43 | 0.22 | 31.4 | ∘ |
| Example 7 | 1.38 | 0.46 | 1.40 | 0.45 | 34.4 | ∘ |
| Example 8 | 1.37 | 0.38 | 1.38 | 0.33 | 33.2 | ∘ |
| Comparative | 1.43 | 0.72 | 1.43 | 0.77 | 38.2 | ∘ |
| Example 1 | | | | | | |
| Comparative | 1.33 | 0.33 | 1.29 | 0.99 | 33.3 | x |
| Example 2 | | | | | | |

TABLE 3

| | | | After 3000 times | | | |
|---|---|---|---|---|---|---|
| | Initial | | | | Toner | Toner |
| | ID | BG | ID | BG | consumption | dusting |
| Example 1 | 1.40 | 0.70 | 1.39 | 0.72 | 28.5 | ∘ |
| Comparative | 1.40 | 0.77 | 1.28 | 1.05 | 31.6 | ∘ |
| Example 1 | | | | | | |

As shown in Table 2, the developers of the present invention do not have problems in image density, fogging, toner consumption, and toner dusting.

In Comparative Example 1, toner consumption was large since polyester resin was used as the binder resin of the toner. Furthermore, it has a problem in environmental resistance in that image density was deteriorated and fogging was increased after copying 3000 times under low temperature and low humidity.

In Comparative Example 2, image density was low, and fogging and toner dusting were large since styrene-acrylic acid ester resin was used as the binder resin of the toner.

As explained above, the developer for electrophotography in which environmental resistance is superior, appropriate image density is maintained, and fogging and toner dusting are minimized even after a large number of copies are made, can be provided by the present invention.

1. A developer for electrophotography comprising:
a carrier; and
a magnetic toner containing cyclo-olefin copolymer resin as a binder resin.

2. The developer for electrophotography according to claim 1, wherein saturation magnetization of the magnetic toner St at an external magnetic field of 5 kOe when saturation magnetization of the carrier at an external magnetic field of 5 kOe is defined as Sc, is in a range of 0.10 Sc≦St≦0.40 Sc.

3. The developer for electrophotography according to claim 1, wherein the carrier has a structure in which a surface of a core particle is coated by a resin coating agent.

4. The developer for electrophotography according to claim 1, wherein the carrier is a magnetic material dispersed resin carrier.

5. The developer for electrophotography according to claim 1, wherein the magnetic toner contains wax having a melting point in a range from 60 to 100° C.

6. The developer for electrophotography according to claim 1, wherein the binder resin contains cyclo-olefin copolymer resin in a range from 50 to 100 wt %.

7. The developer for electrophotography according to claim 1, wherein 0.1 to 1.5 wt % of hydrophobic silica fine particles as a fluidizing agent adhere to the magnetic toner.
